(19) United States
(12) Patent Application Publication
(10) Pub. No.: US 2021/0394293 A1
(43) Pub. Date: Dec. 23, 2021

(54) WELDING METHOD FOR PROVIDING SHAPE TO A BASE MATERIAL AND A BASE MATERIAL USED FOR SAME

(71) Applicants: HYUNDAI MOTOR COMPANY, Seoul (KR); KIA MOTORS CORPORATION, Seoul (KR); HWASHIN CO., LTD., Yeongcheon-si (KR)

(72) Inventors: Mun-Gu Kang, Suwon-si (KR); Min-Soo Kim, Seoul (KR); Young-Rae Jo, Seoul (KR); Byeong-Nyun Kim, Daegu (KR); Seung-Geol Baek, Yeongcheon-si (KR)

(73) Assignees: HYUNDAI MOTOR COMPANY, Seoul (KR); KIA MOTORS CORPORATION, Seoul (KR); HWASHIN CO., LTD., Yeongcheon-si (KR)

(21) Appl. No.: 17/081,409

(22) Filed: Oct. 27, 2020

(30) Foreign Application Priority Data
Jun. 19, 2020 (KR) 10-2020-0074719

(51) Int. Cl. B23K 9/028; B23K 9/23; B23K 33/00

(52) U.S. Cl. CPC B23K 9/028; B23K 33/00; B23K 9/23

(57) ABSTRACT

A welding method includes: forming one or more lower plate grooves having a predetermined width and a predetermined depth at one side of an upper surface of a lower plate; forming one or more upper plate grooves having a predetermined width and a predetermined depth at one side of a lower surface of an upper plate; overlapping the lower plate and the upper plate so that the lower plate grooves of the lower plate and the upper plate grooves of the upper plate mesh with one another; and performing welding to form a bead at a welding part.

### CROSS-REFERENCE TO RELATED APPLICATIONS

This application claims priority under 35 U.S.C. § 119 to Korean Patent Application No. 10-2020-0074719, filed on Jun. 19, 2020, in the Korean Intellectual Property Office, the disclosure of which is incorporated herein by reference in its entirety.

### BACKGROUND

### 1. Field of the Disclosure

The present disclosure relates to a welding method, and more particularly, to a welding method that forms a bead at a welding part.

### 2. Description of the Related Art

In general, a welding process is performed to join metallic materials.

Welding methods include arc welding and laser welding. Arc welding refers to a welding method that melts welding parts of base materials by using heat of an arc generated between the base materials and a welding rod. Molten metal from the welding rod is added to the welding parts to join the base materials. Laser welding refers to a welding method that emits laser beams to base materials and melts the base materials to join the base materials.

FIG. 1 is a schematic cross-sectional view illustrating a state in which welding is performed by a general welding process and in which two base materials are joined.

Referring to FIG. 1, when the welding is performed about a root R, which is a position at which an outermost point of a lower edge of an upper plate is placed on an upper surface of a lower plate 1, welding parts of the base materials are melted, and molten metal from a welding rod is added to the welding parts. The welding is performed in a state in which the upper plate 2 made of metal is mounted on the lower plate 1 made of metal. Thus, a bead 3 having a predetermined volume is created about the root R over an upper space portion of the lower plate 1 and a lateral space portion of the upper plate 2.

In this case, an entirely uniform shape of the bead 3 needs to be maintained to prevent a deterioration in durability and quality. To this end, it is necessary to often measure and check the shape of the bead on the welding part while the welding process is performed.

In order to measure the shape of the bead, a process of checking whether the bead is uniformly formed is performed by measuring a dimension of a throat thickness W, which is a distance between a point of the root R in the bead 3 and a point at which an extension line extending from the point of the root R in a direction of 45° meets a surface of the bead 3. The process of checking whether the bead is uniformly formed is further performed by measuring a dimension of a leg length L which is a distance between the point of the root R and a point at which a horizontal extension line extending from the point of the root R meets the surface of the bead 3.

If the throat thickness W and the leg length L of the bead are not formed uniformly, it means that a welding area to the lower plate 1 and a welding area to the upper plate 2 are different from each other. For this reason, the corresponding parts have different welding strength, which causes concern that structural durability deteriorates. Therefore, it is necessary to carefully perform the welding process to provide a uniform dimension of the throat thickness W and a uniform dimension of the leg length L of the bead 3.

However, additional time and manpower are required to check the dimensions of the bead 3. Therefore, there is a need for development of a method capable of effectively checking quality of the welding part while minimizing required time and manpower.

The point of the root R can be clearly ascertained before the welding process, but the point of the root R cannot be clearly ascertained after the bead 3 is formed by the welding process because the bead 3 is formed after the welding process. Thus, there may inevitably occur an error when measuring the throat thickness W and the leg length L. Therefore, in actual practice, the root R is assumed based on an imaginary line running through an inflection point of the molten upper plate 2, and the throat thickness W and the leg length L are measured based on the assumed root.

For this reason, the root R, which is a reference point, becomes ambiguous after the welding process. Thus, numerical values of the throat thickness W and the leg length L also become ambiguous. As a result, there is a problem in that a volume of the bead 3 cannot be accurately measured. There is also a limitation in predicting insufficient melting of the base material caused by a low heat input, and in predicting a deterioration in a physical property of the base material caused by an excessive heat input.

Meanwhile, a welding methods and technologies of forming a uniform shape of a bead is disclosed in Japanese Patent No. JP3772731 (Document 1), Japanese Patent No. JP4090599 (Document 2), and Japanese Patent Laid-Open No. S58-148079 (Document 3). However, the technologies according to Documents 1-3 cannot solve the various problems in the related art because these technologies cannot accurately evaluate the amount of weld penetration.

### SUMMARY

The present disclosure has been made in an effort to provide a welding method that provides a predetermined shape to a surface of a base material in order to accurately measure a shape of a bead formed on the base material after a welding process. The welding method further enables a user to accurately measure the shape of the bead with the naked eye after the welding process based on the predetermined shape. Thus, the user may easily evaluate the amount of weld penetration based on the shape of the bead.

An embodiment of the present disclosure provides a welding method including: forming one or more lower plate grooves having a predetermined width and a predetermined depth at one side of an upper surface of a lower plate; forming one or more upper plate grooves having a predetermined width and a predetermined depth at one side of a lower surface of an upper plate; overlapping the lower plate and the upper plate so that the lower plate grooves of the lower plate and the upper plate grooves of the upper plate mesh with one another; and performing welding to form a bead at a welding part.

According to the welding method of the present disclosure configured as described above, the grooves formed in the base materials make it easy to ascertain the leg length and the throat thickness used to measure the shape of the bead. Thus, it is possible to accurately check whether the bead is uniformly formed, thereby improving durability of a product.

It is also possible to accurately ascertain the shape of the bead formed on the base materials. Thus, it is possible to easily evaluate the amount of weld penetration during welding, and it is possible to reduce required time and manpower in comparison with the method of checking a bead in the related art.

The amount of weld penetration may be substantially increased by the grooves formed in the base materials, thereby more rigidly joining the base materials.

### BRIEF DESCRIPTION OF THE DRAWINGS

FIG. 1 is a schematic cross-sectional view illustrating a state in which welding is performed by a general welding process.

FIG. 2 is a schematic cross-sectional view illustrating a state before base materials, which are provided with shapes according to the present disclosure, are welded.

FIGS. 3A and 3B are enlarged views of an upper plate and a lower plate, which are provided with the shapes according to the present disclosure.

FIG. 4 is a schematic cross-sectional view illustrating a state after the base materials, which are provided with the shapes according to the present disclosure, are welded.

FIG. 5 is a detailed view illustrating groove portions formed in the base material.

FIGS. 6A-6D and 7A-7D are cross-sectional views of embodiments of the base material provided with the shape according to the present disclosure, in which FIGS. 6A-6D illustrate cross sections of the base materials according to the embodiments having various shapes and in which FIGS. 7A-7D illustrate cross sections of the base materials according to the embodiments in which different shapes are periodically formed.

FIG. 8 is an enlarged view illustrating a state in which the upper plate and the lower plate according to the present disclosure engage with each other.

FIG. 9 is a graph illustrating widths of the groove portions with respect to thicknesses of the base materials.

FIGS. 10A-10C are photographs illustrating cross sections in which the shape according to the present disclosure is provided only to the upper plate, in which FIG. 10A is a photograph illustrating the cross section before welding, FIG. 10B is a photograph illustrating the cross section in a state after welding, and FIG. 10C is a photograph illustrating the cross section in a state after welding base materials in the related art.

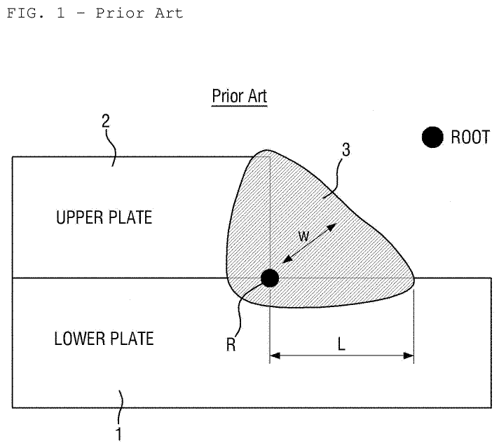

### DETAILED DESCRIPTION OF THE EMBODIMENTS

Hereinafter, a welding method of providing a shape to a base material and a base material used for the same according to the present disclosure are described in detail with reference to the drawings.

However, the disclosed drawings are provided as an example for fully transferring the spirit of the present disclosure to those having ordinary in the art. Therefore, the present disclosure is not limited to the drawings disclosed below and may be specified as other aspects.

Unless otherwise defined, the terminologies used in the specification of the present disclosure have the meanings that those having ordinary skill in the technical field to which the present disclosure pertains typically understand. In the following description and the accompanying drawings, a detailed description of publicly known functions and configurations has been omitted so as to avoid unnecessarily obscuring the subject matter of the present disclosure.

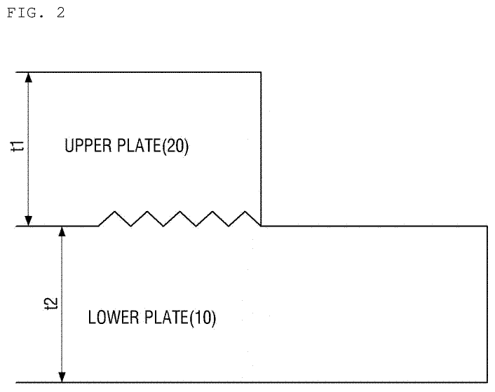

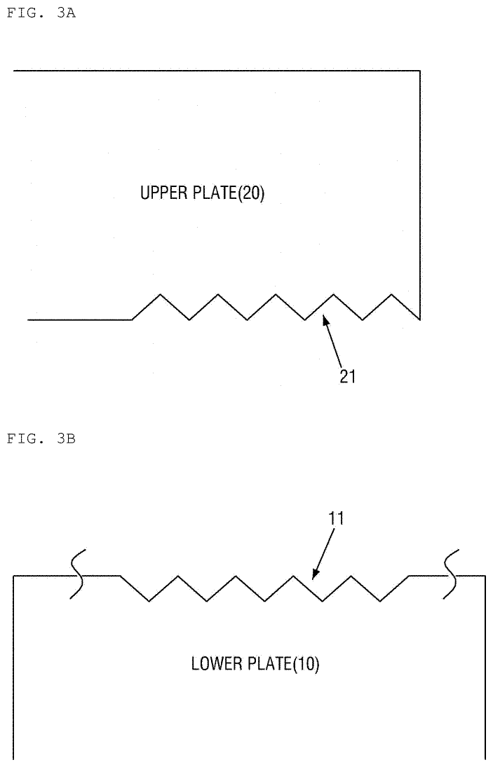

FIG. 2 is a schematic cross-sectional view illustrating a state before base materials, which are provided with shapes according to the present disclosure, are welded. FIGS. 3A and 3B are enlarged views of an upper plate and a lower plate, which are provided with the shapes according to the present disclosure.

First, referring to FIG. 2, base materials are used for a welding method of providing a shape to a base material according to the present disclosure. The base materials include a lower plate 10, which is a base material made of metal and positioned at a lower side, and an upper plate 20, which is a base material made of metal, positioned at an upper side of the lower plate 10, and attached to the lower plate 10 by welding.

In addition, as illustrated in FIGS. 3A and 3B, the base materials according to the present disclosure include the lower plate 10 having one or more lower plate grooves 11 having a predetermined width and a predetermined depth and formed at one side of an upper surface of the lower plate 10, and the upper plate 20 having one or more upper plate grooves 21 having a predetermined width and a predetermined depth and formed at one side of a lower surface of the upper plate 20.

In this embodiment, the lower plate grooves 11 of the lower plate 10 and the upper plate grooves 21 of the upper plate 20 may be formed to mesh with one another.

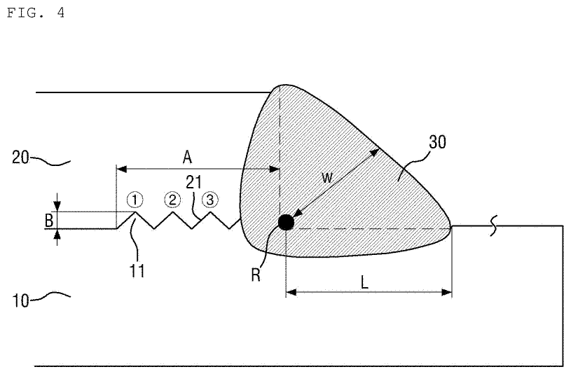

FIG. 4 is a schematic cross-sectional view illustrating a state after a welding process is performed by using the lower plate 10 and the upper plate 20 according to the present disclosure configured as described above. When the welding is performed about a root R, which is an outermost point of a lower edge of the upper plate 20 placed on the upper surface of the lower plate 10, welding parts of the base materials are melted, and molten metal from a welding rod is added to the welding parts. The welding process is performed in a state in which the upper plate 20 is mounted on the lower plate 10 so that the lower plate grooves 11 formed in the lower plate 10 and the upper plate grooves 21 formed in the upper plate 20 mesh with one another. Thus, a bead 30 having a predetermined volume is formed about the root R over an upper space portion of the lower plate 10 and a lateral space portion of the upper plate 20, as illustrated.

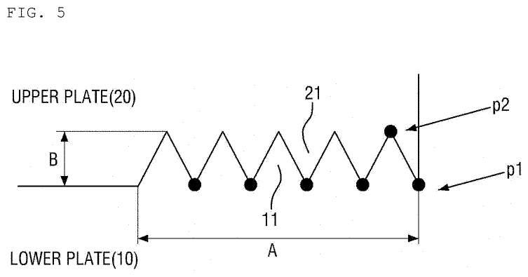

In this embodiment, as illustrated in FIG. 5, an overall length A and an overall width B of the grooves 11 or 21 formed in the lower plate 10 or the upper plate 20 according to the present disclosure should be apparent, and a thickness t of the base material should be apparent. As illustrated in FIG. 4, an overall length and an overall width of the grooves 11 or 21 remaining without being covered by the bead 30 are measured when the bead 30 is formed after welding. The bead 30 is observed from a lateral side of the welding part, and the overall length and the overall width are compared with an overall length A and an overall width B before welding. Thus, it is possible to accurately recognize the position of the root R when the two base materials 10 and 20 are joined by welding. A throat thickness W and a leg length L of the bead 30 are easily calculated based on the recognized position of the root R. Thus, the uniformity of the entire shape of the bead 30 on the structure may be ascertained. Further, with the presence of the grooves 11 and 21, the amount of weld penetration of the molten materials to be inputted to the bead 30 is increased.

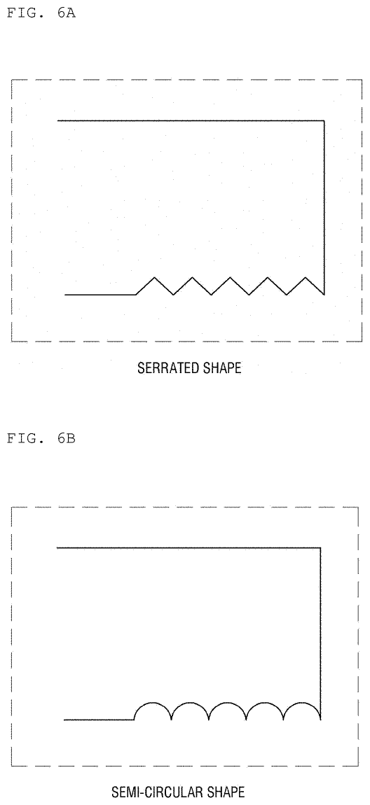

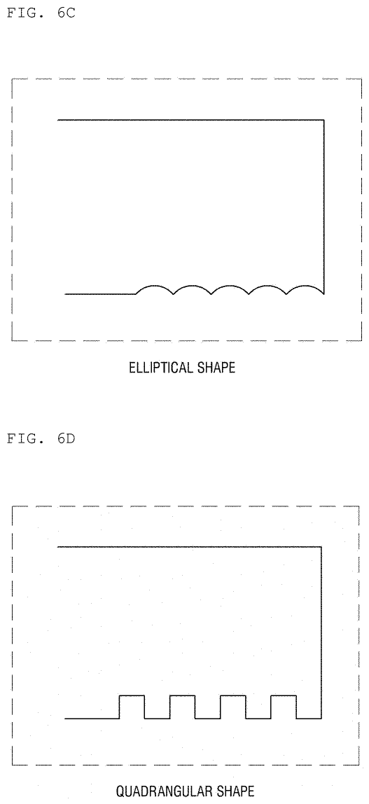

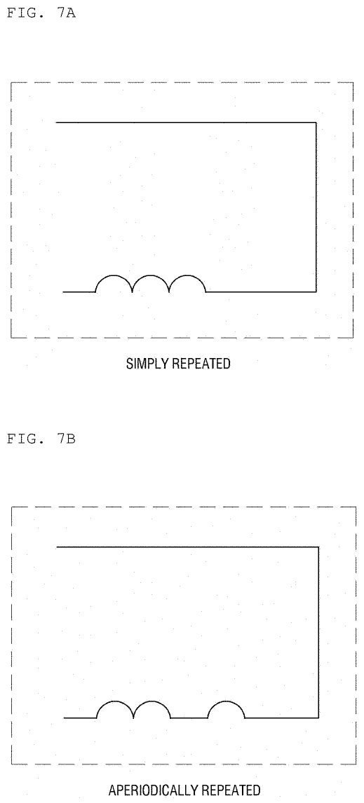

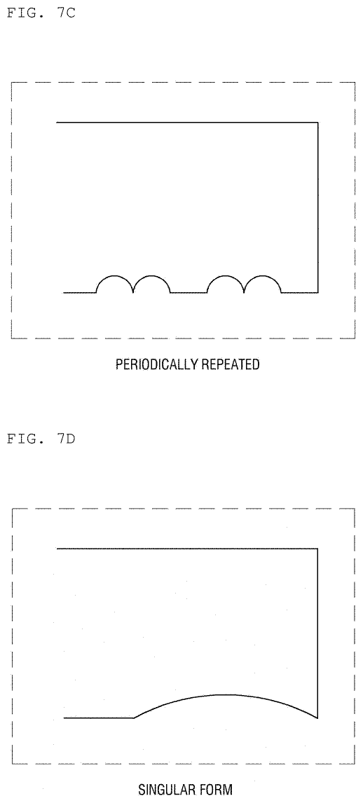

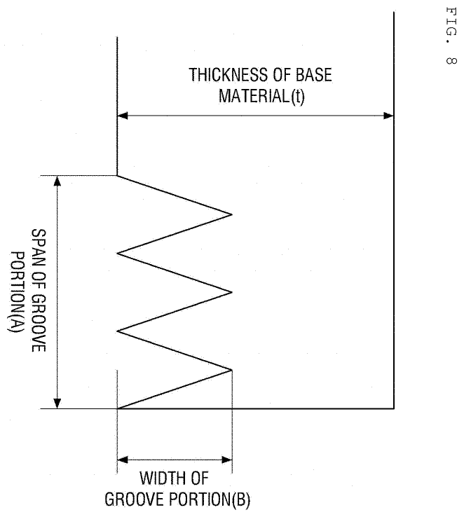

The grooves 11 and 21 formed in the lower plate 10 and the upper plate 20 according to the present disclosure may be formed to have various shapes and periodically repeated patterns. For example, as illustrated in FIGS. 6A-6D and 7A-7D, the groove 21 formed in the upper plate 20 is formed in a serrated shape, a semi-circular shape, an elliptical shape, or a quadrangular shape. The grooves 21 may be formed to have various repeated patterns such as simply repeated patterns, aperiodically repeated patterns, periodically repeated patterns, and a single pattern. The shape or the pattern may also be identically applied to the groove 11 formed in the lower plate 10.

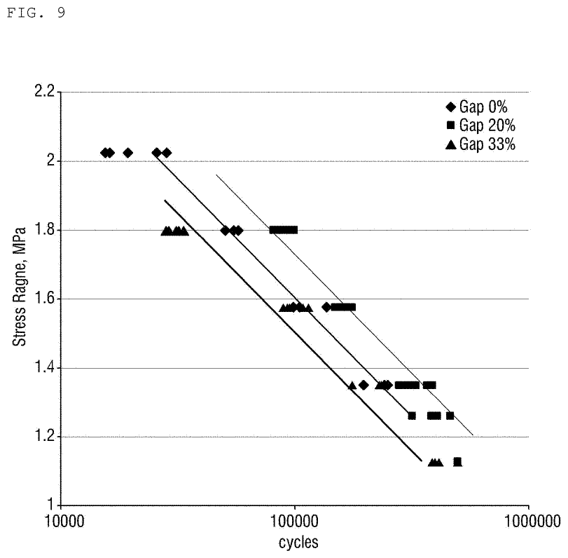

Meanwhile, FIG. 8 is an enlarged view illustrating a state in which the upper plate 20 and the lower plate 10 according to the present disclosure are engaged with each other. According to the embodiment of the present disclosure, there may be a non-contact portion p2 where at least one pair of grooves, among the grooves 11 and 21 formed in the lower and upper plates 10 and 20, which mesh with one another, is not in contact with each other. Therefore, except for the non-contact portion p2 (as shown in FIG. 5), there are contact portions p1 (as shown in FIG. 5) where the other pairs of grooves are in contact with one another.

According to the embodiment of the present disclosure, as illustrated in FIG. 2, a thickness t2 of the lower plate 10 may be 0.1 to 80.0 mm, and a thickness t1 of the upper plate 20 may be 0.1 to 40.0 mm. As illustrated in FIG. 5, an overall length A of the grooves 11 and 21 may be set within a range defined by the following Expression 1.

0.5×t min<A<2.0×t min (Expression 1)

*t min: a thickness of the base material which is the smaller of a thickness t1 of the upper plate 20 and a thickness t2 of the lower plate 10

*A: an overall length of the grooves

A width B of the grooves 11 and 21 may be set within a range defined by the following Expression 2.

B<0.2×t min (Expression 2)

*t min: a thickness of the base material which is the smaller of a thickness t1 of the upper plate 20 and a thickness t2 of the lower plate 10

*B: a width of the grooves

That is because the leg length L of the bead 30 needs to be equal to or larger than 1.0×t min with respect to the thickness of the base material when the bead 30 is formed by welding so that the lower plate 10 and the upper plate 20 according to the present disclosure overlap each other. Thus, the overall length A of the grooves 11 and 21 and the width B of the grooves 11 and 21 according to the present disclosure are limited within a range equal to or smaller than twice the general leg length. In this manner, the grooves 11 and 21 may be formed to a minimum extent without being excessively formed. Further, the width B of the grooves 11 and 21 is equal to or smaller than at most 20% of the thickness of the upper plate 20 or the lower plate 10 and equal to or larger than at least 0.1 mm. If the width B of the grooves 11 and 21 is smaller than 0.1 mm, the grooves 11 and 21 cannot be recognized with the naked eye, and as a result, there is a drawback in that the grooves 11 and 21 cannot be immediately recognized in situ.

FIG. 9 is a graph illustrating widths of the groove portions with respect to thicknesses of the base materials.

Referring to the graph, in a case in which there is a gap of 20% of the thickness of the base material, the base material has excellent fatigue properties in comparison with a specimen having no gap (0%). This is because the gap reduces and restricts deformation caused by a load applied during a fatigue test.

In contrast, in a case in which there is a gap of 33% or more of the thickness, fatigue strength is reduced due to bending stress to the specimen and to concentration of stress to the shape during the fatigue test.

Therefore, the width B of the grooves 11 and 21 according to the present disclosure may be equal to or smaller than at most 20% of the thickness of the upper plate 20 or the lower plate 10.

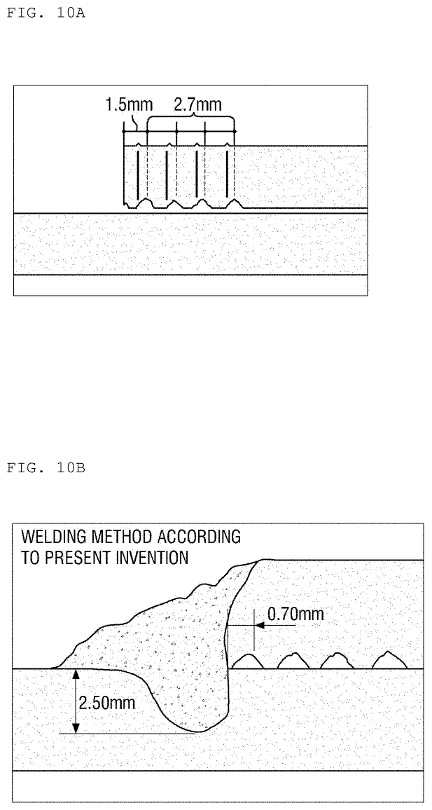

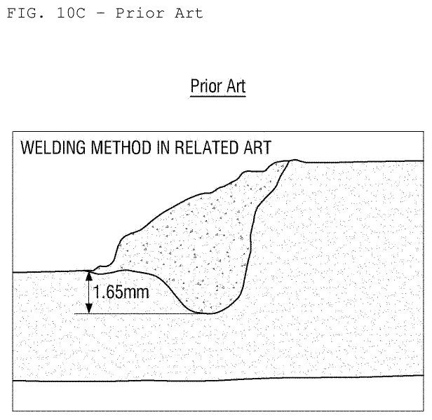

FIGS. 10A-10C are photographs illustrating cross sections in which the shape according to the present disclosure is provided only to the upper plate 20. FIG. 10A illustrates a cross section before welding, FIG. 10B illustrates a cross section after welding, and FIG. 10C illustrates a cross section after welding base materials in the related art.

FIGS. 10A-10C illustrate another embodiment according to the present disclosure in which the grooves 21 are formed only in the upper plate 20, and the lower plate 10 has no groove.

In this embodiment, as illustrated in FIG. 10A, an overall length of the four grooves 21 formed in the upper plate 20 is 4.2 mm obtained by 1.5 mm+2.7 mm, and as illustrated in FIG. 10B, 0.7 mm is indicated from the end of the upper plate 20 to the portion where the groove 21 is formed after welding. As a result, it is possible to easily ascertain with the naked eye that a length of the upper plate 20 melted by welding is 0.8 mm made by subtracting 0.7 mm from 1.5 mm. Therefore, the position of the root R of the bead 30 may be accurately recognized, such that the leg length L and the throat thickness W of the bead 30 may also be easily ascertained.

Further, as illustrated in FIG. 10B, it may be ascertained that the amount of weld penetration of the lower plate 10 is 2.5 mm. Therefore, it may be ascertained that the amount of weld penetration according to the present disclosure is further increased and the welding part becomes more rigid because of the increase in the amount of weld penetration. By comparison, the amount of weld penetration of the lower plate is 1.65 mm as illustrated in FIG. 10C, in a case in which the welding is performed by using base materials having no grooves in the related art.

What is claimed is:

1. A welding method of welding base materials comprising a lower plate which is a base material made of metal and positioned at a lower side, and an upper plate which is a base material made of metal, positioned at an upper side of the lower plate, and attached to the lower plate by welding, the welding method comprising:
forming one or more lower plate grooves having a predetermined width and a predetermined depth at one side of an upper surface of the lower plate;
forming one or more upper plate grooves having a predetermined width and a predetermined depth at one side of a lower surface of the upper plate;
overlapping the lower plate and the upper plate so that the lower plate grooves of the lower plate and the upper plate grooves of the upper plate mesh with one another; and
performing the welding to form a bead at a welding part.

2. The welding method of claim 1, wherein each of the grooves formed in the lower and upper plates is formed in any one of a serrated shape, a semi-circular shape, an elliptical shape, and a quadrangular shape.

3. The welding method of claim 1, wherein a shape of each of the grooves formed in the lower and upper plates has any one of a simply repeated pattern, an aperiodically repeated pattern, a periodically repeated pattern, and a single pattern.

4. The welding method of claim 1, wherein there is a non-contact portion p2 where at least one pair of grooves, among the grooves formed in the lower and upper plates which mesh with one another, is not in contact with each other.

5. The welding method of claim 1, wherein a thickness t2 of the lower plate is 0.1 to 80.0 mm, and a thickness t1 of the upper plate is 0.1 to 40.0 mm.

6. The welding method of claim 1, wherein an overall length A of the grooves is set within a range defined by an Expression 1,
0.5×t min<A<2.0×t min (Expression 1)
where t min is a thickness of the base material which is the smaller of a thickness t1 of the upper plate and a thickness t2 of the lower plate, and
where A is an overall length of the grooves.

7. The welding method of claim 1, wherein a width B of the grooves is set within a range defined by an Expression 2,
B<0.2×t min (Expression 2)
where t min is a thickness of the base material which is the smaller of a thickness t1 of the upper plate and a thickness t2 of the lower plate, and
where B is a width of the grooves.

8. A welding method of welding base materials comprising a lower plate which is a base material made of metal and positioned at a lower side, and an upper plate which is a base material made of metal, positioned at an upper side of the lower plate, and attached to the lower plate by welding, the welding method comprising:
forming one or more grooves having a predetermined width and a predetermined depth in any one of the lower plate and the upper plate;
overlapping the two base materials; and
performing the welding to form a bead at a welding part.

9. Base materials comprising:
a lower plate made of metal and having one or more lower plate grooves having a predetermined width and a predetermined depth formed at one side of an upper surface of the lower plate; and
an upper plate made of metal and having one or more upper plate grooves having a predetermined width and a predetermined depth formed at one side of a lower surface of the upper plate,
wherein the lower plate and the upper plate overlap each other so that the lower plate grooves of the lower plate and the upper plate grooves of the upper plate mesh with one another, and
wherein welding is performed to form a bead at a welding part.

10. The base material of claim 9, wherein a thickness t2 of the lower plate is 0.1 to 80.0 mm, and a thickness t1 of the upper plate is 0.1 to 40.0 mm.

11. The base material of claim 9, wherein an overall length A of the grooves is set within a range defined by an Expression 1,
0.5×t min<A<2.0×t min (Expression 1)
where t min is a thickness of the base material which is the smaller of a thickness t1 of the upper plate and a thickness t2 of the lower plate, and
where A is an overall length of the grooves.

12. The base material of claim 9, wherein a width B of the grooves is set within a range defined by an Expression 2,
B<0.2×t min (Expression 2)
where t min is a thickness of the base material which is the smaller of a thickness t1 of the upper plate and a thickness t2 of the lower plate, and
where B is a width of the grooves.
